(19) United States
(12) Patent Application Publication
(10) Pub. No.: US 2021/0070036 A1
(43) Pub. Date: Mar. 11, 2021

(54) HEATING LAMP AND RESISTIVE DRYER CONTROL

(71) Applicant: Hewlett-Packard Development Company, L.P., Spring, TX (US)

(72) Inventors: Duane A Koehler, Vancouver, WA (US); Robert Yraceburu, Vancouver, WA (US); Francisco Alcazar, Vancouver, WA (US)

(21) Appl. No.: 15/733,798

(22) PCT Filed: Aug. 31, 2018
(86) PCT No.: PCT/US2018/049238

§ 371 Date: Oct. 28, 2020

(51) Int. Cl. B41F 23/04; B41F 33/16; B41J 11/00; F26B 25/22

(52) U.S. Cl. CPC B41F 23/0416; B41F 23/0459; F26B 25/22; B41J 11/002; B41F 33/16

(57) ABSTRACT

According to examples, an apparatus may include a processor and a nontransitory computer readable medium on which is stored machine readable instructions that are to cause the processor to generate a linear piecewise control signal based on an internal resistance of a heating lamp to control a rate of change of a phase angle of an applied voltage in the heating lamp until a peak current in the heating lamp is within a predefined threshold of a maximum current rating of an alternating current (AC) power source of a circuit.

### BACKGROUND

Printing images or text on printable media in a printer includes various media processing activities, including pick-up, delivery to a print engine, printing, and conditioning of sheets of printable media. Conditioning may involve heating and pressing the sheets through or past a heated conveying component, such as a heated pressure roller (HPR), to remove liquid (for printers using liquid ink), to remove wrinkles or curvature, and/or to reform or flatten fibers in the sheets. Other examples of conditioners may include a resistive dryer or a heating lamp.

### BRIEF DESCRIPTION OF DRAWINGS

Features of the present disclosure are illustrated by way of example and not limited in the following figure(s), in which like numerals indicate like elements, in which:

FIG. 1A depicts a block diagram of an example apparatus that may generate control signals for a resistive dryer and a heating lamp;

FIG. 1B depicts a block diagram of an example heated system that may include the apparatus depicted in FIG. 1A, in which the apparatus may control a heat generating device during both a ramping up period and a transition to a steady state temperature control operation;

FIG. 2 shows a schematic diagram of the example heated system that may include the apparatus depicted in FIG. 1A;

FIG. 3 shows an example graph of linear phase control signal and control of the heating lamp and the resistive dryer for the heated system depicted in FIGS. 1B and 2;

FIG. 4 depicts a flow diagram of an example method for controlling a resistive dryer and a heating lamp in a heated system; and

FIG. 5 shows an example non-transitory computer readable storage medium for controlling a heating lamp and a resistive dryer in a heated system.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Many printers, such as inkjet printers, may include a heated system that may, for example, help reduce media curl and ink smear, and may improve quality in printed output. Examples of heated systems may include dryers, fusers, pressure rollers, calendaring rollers, etc. Heated systems may include a heat generating device that, when a media is to be conditioned may be supplied with a maximum amount of available power to quickly ramp up the temperature in the heated system to a target temperature. By supplying the maximum amount of available power during the ramp up period, the temperature may be increased to the target temperature in a minimized length of time. Following the ramp up period, the temperature in the heated system may be maintained at or near the target temperature for a duration of a print job, e.g., during a steady state operation period using a maintenance control signal that may have a faster rate of change of phase of applied voltage.

Some heated systems may include both a heating lamp and a resistive dryer. During a ramp up period, the heating lamp may have a short thermal time constant, whereas the resistive dryer may have a high thermal time constant. In a printer with a fixed AC power, it may be difficult to both meet a target first printout time and comply with Conducted Emissions (CE) and flicker guidelines while heating the heating lamp from a cold state. For example, the resistive dryer may use a quick phase shift from 0 to 180 of the voltage to minimize the first print out time, whereas the heating lamp, when cold, may have a lower resistance and therefore, to prevent current spikes (which in turn may cause flicker), may use a relatively slow phase change.

Disclosed herein are apparatuses, heated systems, methods, and machine readable instructions that may control the temperature of the heating lamp and the resistive dryer during both a ramp up period and a steady state period of the heated system that may comply with CE, flicker guidelines and target first printout time specifications when a heated system is turned on after a prolonged cooling off period where the heated system is at a certain percentage of the ambient temperature. Particularly, a processor of a heated system disclosed herein may cause the resistive dryer, which may have a resistance that is relatively constant with temperature changes, to be warmed using the full 180 degrees of the voltage waveform applied to the resistive dryer. In addition, the apparatuses, heated systems, methods, and machine readable instructions disclosed herein may smooth the delivery of power to heated systems. By smoothing the delivery of power, power line harmonics and conducted EMC emissions may be improved, and/or flicker may be reduced. In addition, smoothing of the power delivery may reduce the amount of phase control used to warm up heating lamps in the heated system, which may cause conducted emissions to be reduced, such that the size and cost of AC line filters may be reduced, and the heating lamps may be warmed up in a relatively shorter length of time, which may improve a first page out time.

Application of the full 180 degrees of the voltage waveform may be referred to as “half-cycle control.” Similarly, the processor disclosed herein may cause the heating lamp, which may have a resistance that varies with temperature changes, to be warmed using phase control to avoid excessive current being drawn from an AC circuit. In order to achieve the target first page out time when using phase control, the processor may increase the phase angle at the maximum rate possible that will not cause high current transients and fluctuations in power delivery, power-line flicker, and/or the like.

As discussed herein, supplying the maximum power to a heating lamp with an internal resistance that varies with temperature and a resistive dryer with a more stable internal resistance within a first page out time may be achieved using linear phase control signal, a half-cycle control signal and a resistive dryer control signal. In an example, the linear phase control signal may vary the phase of an applied voltage across a heating lamp based on its internal resistance to reduce flicker and/or Conducted Emissions (CE). Also, a maintenance control signal that may have a faster phase change for the heating lamp compared to the ramp up linear control signal may be applied when the heating lamp is warmer. The linear phase control signal to supply voltage across the heating lamp may be truncated based on a nominal time needed to get the heating lamp to a temperature such that its internal resistance is sufficiently high to reduce power fluctuations. As a result, flicker inducing current spikes may be reduced, which may enable regulatory requirements to be met. The nominal time needed to get the heating lamp to the temperature may depend on specifications of the heating lamp and may be determined experimentally, empirically, or based on the thermal coefficient of the heating lamp.

In examples, the processor disclosed herein may generate a piecewise control signal for a servo to change the phase angle at a slower linear rate of change when the heating lamp is cold until the heating lamp reaches a first resistance, change the phase angle at a second linear rate of change following the heating lamp reaching the first resistance until the heating lamp resistance reaches or is above a second resistance (e.g., a predefined minimum resistance), and change the phase angle at a third linear rate of change until the peak voltage across the heating lamp is within the predefined threshold of a maximum voltage of the AC power source.

According to examples, the processor disclosed herein may allow for the use of a high power heating lamp and a high power resistive dryer because the heating lamp phase shift may be changed based on the heating lamp internal resistance instead of a constant value. Also, the processor may allow for the use of a heating lamp instead of using a ceramic element, which may involve fewer challenges with respect to smooth power delivery, but is relatively fragile as compared to a heating lamp. Therefore, using a heating lamp instead of a ceramic element may involve fewer design changes to a heated system as compared with the use of a ceramic element. In addition, the ceramic element may be more difficult to replace on premises compared with a heating lamp.

Also, the apparatuses and heated systems disclosed herein may not use a more complicated circuit design such as a Sine Wave converter or a high-power DC rail. As a result, the apparatuses and heated systems disclosed herein may function with a reduced number of components and may consume less power than apparatuses that have the more complicated circuit designs. For example, the high-power DC rail may operate by converting the line voltage from AC to DC. The processor disclosed herein may use AC power and may thus avoid conversion losses during heating of the heating lamp and the resistive dryer.

Throughout the present disclosure, the terms “a” and “an” are intended to denote one of a particular element or multiple ones of the particular element. As used herein, the term “includes” means includes but not limited to, the term “including” means including but not limited to. The term “based on” may mean based in part on.

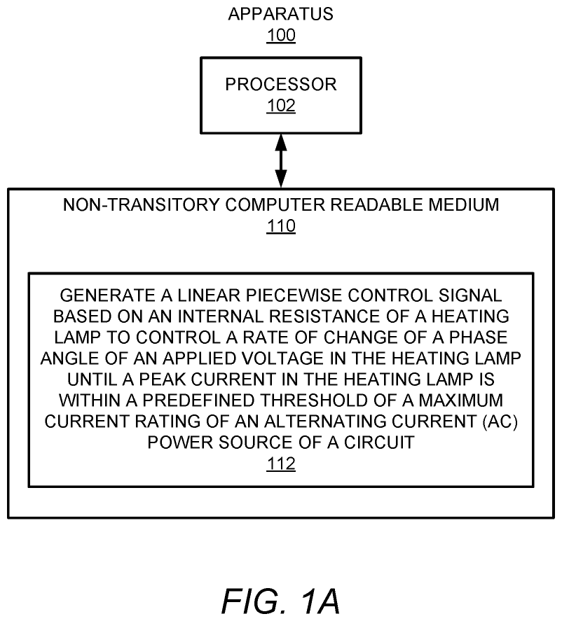

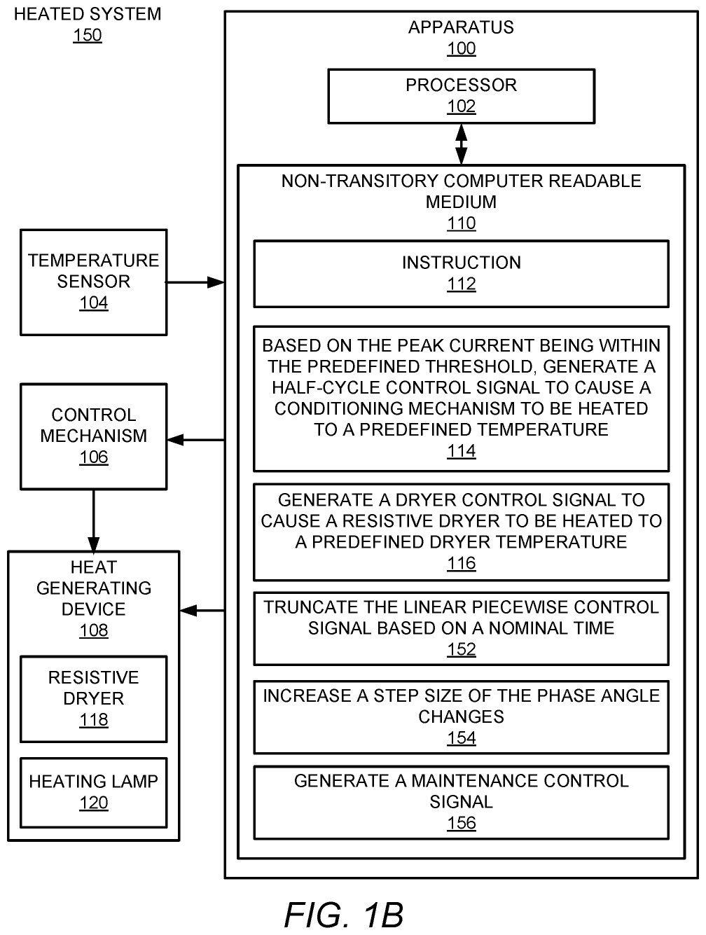

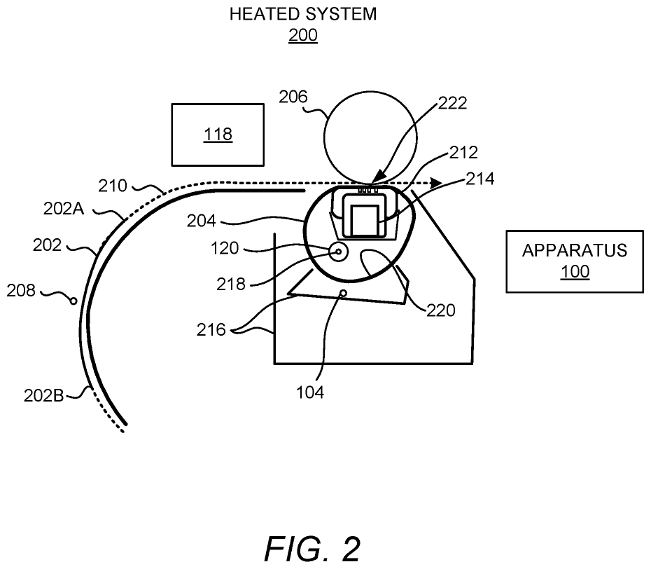

Reference is first made to FIGS. 1A, 1B, and 2. FIG. 1A shows a block diagram of an example apparatus 100 that may generate control signals for a resistive dryer 118 and a heating lamp 120. FIG. 1B shows a block diagram of an example heated system 150 that may include the apparatus 100 depicted in FIG. 1A, in which the apparatus 100 may control a heat generating device 108 during both a ramping up period and a transition to a steady-state temperature control operation. FIG. 2 shows a schematic diagram of another example heated system 200 that may include the apparatus 100 depicted in FIG. 1A. It should be understood that the example apparatus 100 depicted in FIG. 1A and/or the example heated systems 150 and 200 depicted in FIGS. 1B and 2 may include additional features and that some of the features described herein may be removed and/or modified without departing from the scopes of the apparatus 100 and/or the heated systems 150, 200. In addition, it should be understood that the example heated system 200 may have a configuration other than the configuration shown in FIG. 2.

Generally speaking, the apparatus 100 may be a computing apparatus, e.g., a personal computer, a laptop computer, a tablet computer, a smartphone, or the like. In these examples, the apparatus 100 may be separate from a heated system 150, 200 and may communicate instructions to the heated system 150, 200 over a direct or a network connection. In other examples, the apparatus 100 may be part of the heated system 150, 200. In these examples, the apparatus 100 may be part of a control system of the heated system 150, 200 and may communicate instructions to components of the heated system 150, 200, for instance, over a communication bus.

The heated system 150, 200 may be a system in which an object, such as a sheet of media, may be heated. According to examples, the heated system 150, 200 may be part of a media printing system (not shown) in which the heated system 150, 200 may condition, e.g., apply heat, to media upon which a printing medium, e.g., ink, toner, or the like, has been applied. That is, for instance, the heated system 150, 200 may be positioned downstream of a print engine of the media printing system. In other examples, the heated system 150, 200 may be implemented to condition other types of objects, e.g., 3D printed objects, painted objects, or the like.

As shown in FIGS. 1B and 2, the heated systems 150, 200 may include a heat generating device 108, a temperature sensor 104, a control mechanism 106 of the heat generating device 108, and the apparatus 100 depicted in FIG. 1A. In addition, the heat generating device 108 may include a resistive dryer 118 and a heating lamp 120. In examples, the heating lamp 120 and the resistive dryer 118 may heat a sheet of media 202. For instance, the heated system 150, 200 may include a first conveying component coupled to engage a second conveying component to receive, contact, heat, and convey the sheet of media 202. In this example, the first conveying component may be a conditioning mechanism 204, such as a heated belt, and the second conveying component may be a driven roller 206, which may be driven to rotate by a motor (not shown).

The heated system 200 may also include a media sensor 208 disposed along a media path 210, a platen 212, and a platen support structure 214 to support and guide the conditioning mechanism 204, and a chassis 216. In width, the conditioning mechanism (e.g., heated belt), roller 206, platen 212 and the platen support structure 214 may extend “into the page” of FIG. 2. The media sensor 208 may sense and generate a signal in response to a sheet of printable media 202 being proximal the media sensor 208. The media 202 may be moving or may be stationary. The sheet of media 202 may be located on the media path 210 within the sensing range of the media sensor 208. The sheet of media 202 may include a leading edge 202A and a trailing edge 202B, named based on the intended direction of travel of the sheet of media 202. The leading edge 202A may be located beyond the media sensor 208, and the trailing edge 202B has not yet reached the media sensor 208. The media sensor 208 may detect the leading edge 202A, the trailing edge 202B, or the body of the sheet of media 202 between the edges 202A, 202B.

The heating lamp 120 may be a radiant heater, which may include a heating element 218. The heating lamp 120 may extend within the conditioning mechanism 204 to heat a heating zone 220 of the conditioning mechanism 204 by thermal radiation. The heating zone 220 may include the portions of the belt 204 that are in the field of view of the heating lamp 120 at any given moment in time. In various examples, the heated system 150, 200 may include multiple heating lamps 120, which may be designed and arranged to heat different portions of the conditioning mechanism 204. During operation, the roller 206 may conductively be heated by contact with the belt 204, and a length or a piece of media 202, when present, may be heated by contact with the conditioning mechanism 204 and the roller 206. In some examples, the heating lamp 120 may be disposed outside of the belt 204. The heating element 120 may be a halogen-type lamp, but other types of lamps or other types of heating elements may be used to heat the conditioning mechanism 204 and/or the roller 206.

The conditioning mechanism 204 and the roller 206 may contact and press against each other along a nip region 222 to receive and convey the media 202. The nip region 222 may extend along the shared width of the conditioning mechanism 204 and the roller 206. During operation, rotational movement of the roller 206 may drive the conditioning mechanism 204 to rotate by friction or by gearing, with or without media, in between the roller 206 and the conditioning mechanism 204. In addition, the temperature sensor 104 may monitor the temperature of the conditioning mechanism 204 to facilitate control by the processor 102 of the heating lamp 120. The temperature sensor 104 may be a non-contacting thermistor located outside and below the conditioning mechanism 204. Although a single temperature sensor 104 is depicted in FIGS. 1B and 2, additional sensors may be disposed at different locations along the width of the conditioning mechanism 204. Other examples may include another form of non-contact temperature sensor or may include a contact temperature sensor located in another appropriate position.

The resistive dryer 118 of the heat generating device 108 may generate heat that may be directed to the sheet of media 202 as the media 202 is fed to further condition the media 202.

The apparatus 100 may control the heating lamp 120 and the resistive dryer 118 via the control mechanism 106 and may receive input from the temperature sensor 104. Particularly, for instance, the apparatus 100 may determine that the heated system 150, 200 is to be implemented to apply heat to an object, for instance, a sheet of media 202. The apparatus 100 may make this determination based on receipt of an instruction from a processor in a printing device, based on receipt of a signal from the media sensor 208, or the like.

Based on the determination, the apparatus 100 may initiate supply of power to the heating lamp 120 for a period of time and may initiate supply of power to the resistive dryer 118 as discussed in detail herein. The apparatus 100 may directly control the supply of power to the heating lamp 120 and/or the resistive dryer 118, e.g., without implementing the control mechanism 106. In addition, although the control mechanism 106 is depicted as being separate from the apparatus 100, in some examples, the control mechanism 106 may be integral with the apparatus 100. That is, for instance, the control mechanism 106 may be a feedback controller that the apparatus 100 may execute or implement.

As shown in FIGS. 1A and 1B, the apparatus 100 may include a processor 102, which may control operations of the apparatus 100. The processor 102 may be a semiconductor-based microprocessor, a central processing unit (CPU), an application specific integrated circuit (ASIC), a field-programmable gate array (FPGA), graphics processing unit (GPU), a tensor processing unit (TPU), and/or other suitable hardware device. The apparatus 100 may also include a non-transitory computer readable medium 110 that may have stored thereon machine readable instructions 112-116 and 152-156 (which may also be termed computer readable instructions) that the processor 102 may execute. The non-transitory computer readable medium 110 may be an electronic, magnetic, optical, or other physical storage device that contains or stores executable instructions. The non-transitory computer readable medium 110 may be, for example, Random Access memory (RAM), an Electrically Erasable Programmable Read-Only Memory (EEPROM), a storage device, an optical disc, and the like. The term “non-transitory” does not encompass transitory propagating signals.

The processor 102 may fetch, decode, and execute the instructions 112 to generate a linear piecewise control signal to control a rate of change of a phase angle of an applied voltage in the heating lamp 120 until a peak current in the heating lamp 120 is within a predefined threshold of a maximum current rating of an alternating current (AC) power source of a circuit. In an example, the linear piecewise control signal may be based on an internal resistance of the heating lamp 120, while in other examples, the linear piecewise control signal may be based on an internal resistance of the resistive dryer 118. In any of these examples, the processor 102 may generate the linear piecewise control signal to a servo that initiates supply of power to the heat generating device 108 such as the heating lamp 120 and/or the resistive dryer 118.

In examples, the rate of change of the phase angle of the applied voltage in the heating lamp 120 may be at a maximum rate possible while complying with flicker and conducted emissions (CE) regulations. In examples, the predefined threshold of a maximum current rating of an AC power source may be determined experimentally or empirically. In an example, the predefined threshold may be between about 60% and 90% of the maximum current rating of the AC power source. By way of particular example, the predefined threshold may be around 77% of the maximum current rating of the AC power source. In another example, the predefined threshold may be 100%-150% of the maximum current rating of the AC power source for an AC cycle of the AC power source.

As shown in FIG. 1B, the processor 102 may fetch, decode, and execute the instructions 114 to generate, based on the peak current in the heating lamp 120 being within the predefined threshold, a half-cycle control signal to cause a conditioning mechanism 204 to be heated to a predefined temperature using the AC power source at a frequency of the AC power source. The predefined temperature of the conditioning mechanism 204 may be determined through empirical testing, through modeling, or the like, and may thus vary for different types of heated systems. By way of particular example, however, the predefined temperature may be between about 100° C. and about 150° C., although the predefined temperature may be set at other temperatures.

The resistive dryer 118 may have a resistance that is relatively constant with temperature changes. As a result, the resistive dryer 118 may most effectively be warmed using the full 180 degrees of the voltage waveform applied and this is referred to as “half-cycle control.”

As shown in FIG. 1B, the processor 102 may fetch, decode, and execute the instructions 116 to generate a dryer control signal to cause the resistive dryer 118 to be heated to a predefined dryer temperature. In some examples, the processor 102 may generate the dryer control signal concurrently with the generation of the linear piecewise control signal. In an example, the predefined dryer temperature may be determined through empirical testing, through modeling, or the like, and may thus vary for different types of heated systems. The processor 102 may continuously or at set periods of time receive temperature measurement readings from the temperature sensor 104 as the temperature in the heated system 150, 200 changes.

According to examples, the linear piecewise control signal may include three ranges with a different angle ramp rate as shown in Table 1.

TABLE 1

| Phase | | | | Max | | |
|---|---|---|---|---|---|---|
| angle | Starting | | Step | voltage | | |
| range | angle | Step | duration | (% of | Duration | Duration |
| (deg) | (deg) | size | (HC) | RMS) | (HC) | (sec) |
| 0-10 | 1 | 1 | 2 | 17% | 20 | 0.2 |
| deg | | | | | | |
| 11-30 | 12 | 2 | 2 | 50% | 20 | 0.2 |
| deg | | | | | | |
| 31-50 | 32 | 4 | 2 | 77% | 10 | 0.1 |
| HC | | | | | | |
| control . . . | | | | | | |
| TOTAL: | | | | | 50 | 0.5 |

For example, the processor 102 may change the phase angle of the applied voltage at a first rate of change when the heating lamp 120 is activated until the heating lamp 120 reaches a first resistance. When the heating lamp 120 is activated, the heating lamp 120 may start from a nominal rest temperature when the heating lamp 120 has been allowed to equalize towards an ambient temperature. As shown in Table 1, the first ramp up angle may start at 1 degree and may ramp up at 1 degree a step, with a step duration of 2 half cycles until the maximum voltage is 17% of the root mean square voltage (RMS).

Following the heating lamp 120 reaching the first resistance, the processor 102 may change the phase angle of the applied voltage at a second rate of change until the heating lamp 120 reaches a second resistance. The second resistance may be determined experimentally and may refer to a resistance that may allow a faster rate of change of the phase of the voltage compared to when the heating lamp 120 was activated from its nominal rest temperature. The second ramp up angle may start at 12 degrees and may ramp up at 2 degrees for a step, with a step duration of 2 half cycles until the maximum voltage is 50% of the RMS voltage. In addition, following the heating lamp 120 reaching the second resistance, the processor 102 may change the phase angle of the applied voltage at a third rate of change until the peak voltage across the heating lamp 120 is within the predefined threshold of a maximum voltage of the AC power source. The third ramp up angle may change the phase angle of the applied voltage at the third rate of change until the heating lamp 120 internal heating lamp resistance is higher than a nominal resistance such that the maximum current rating for flicker in the AC circuit may not be exceeded when switched to a half-cycle. The third ramp up angle may start at 32 degrees and may ramp up at 4 degrees for a step, with a step duration of 2 half cycles until the maximum voltage is 77% of the RMS voltage.

Also, as shown in FIG. 1B, the processor 102 may fetch, decode, and execute the instructions 152 to, based on a nominal time consumed by the resistive dryer 118 to be heated to a certain dryer temperature, truncate the linear piecewise control signal and use a half cycle control signal before the peak current in the heating lamp 120 is within a predefined current threshold of a maximum current rating of an AC power source of the circuit. In an example, the predefined dryer temperature may be a dryer temperature to allow the media 202 to be dried based on the rate of travel of the media 202 in a printer. For example, as shown in Table 1 above, the heating lamp 120 may be switched to half cycle control before the voltage reaches 77% of the RMS value. In addition, or alternatively, the processor 102 may fetch, decode, and execute the instructions 154 to increase a step size of the phase angle changes in the linear piecewise control signal before the peak current in the heating lamp 120 is within the predefined current threshold of the maximum current rating of the AC power source.

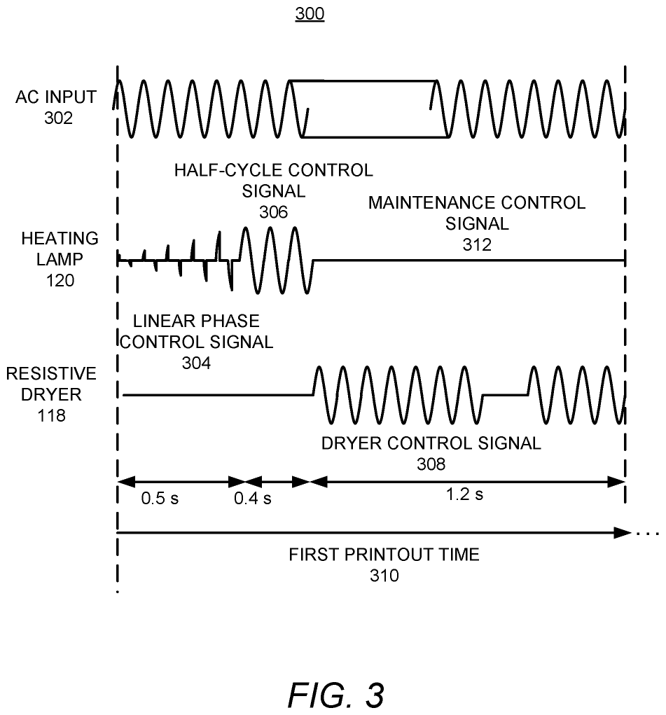

To illustrate the features of FIGS. 1A, 1B, and 2 according to an example, reference is made to FIG. 3, which shows an example graph 300 of the linear phase control signal 304 of the heating lamp 120 and the half cycle control signal of the resistive dryer 118 for the heated system 150, 200 depicted in FIGS. 1B and 2. The graph 300 shows, for example, the AC input signal 302, the linear phase control signal 304 ramp including when the heating lamp 120 is activated and the half-cycle control signal 306 of the heating lamp 120, and a dryer control signal 308 of the resistive dryer 118. As shown, the heating lamp 120 may be heated using three ramps, switched to a half-cycle control signal 306, and controlled to maintain the conditioning mechanism 204 at or near the predefined temperature of the conditioning mechanism 204.

In an example, the processor 102 may generate the linear phase control signal 304, e.g., piecewise phase control signal 304, to cause the heating lamp 120 to be heated based on the internal resistance of the heating lamp 120 such that the current drawn does not exceed the maximum current of the current source or fail to comply with flicker and conducted emissions (CE) regulations. The processor 102 may cause the heating lamp 120 to be heated at a first rate of change of phase of the voltage across the heating lamp 120 when the heating lamp 120 is activated until the internal heating lamp resistance reaches a first resistance. The processor 102 may cause the heating lamp 120 to be heated at a second rate of change of phase of the voltage across the heating lamp 120 until the internal resistance of the heating lamp 120 reaches a second resistance. The processor 102 may cause the heating lamp 120 to be heated at a third rate of change of phase of the voltage across the heating lamp 120 until the peak voltage across the heating lamp 120 is within the predefined threshold of the maximum voltage of the AC power source.

In an example, the processor 102 may generate the linear piecewise control signal 304 to be calibrated to prevent a current surge that exceeds a rated current of the AC power source. In an example, the processor 102 may generate the linear piecewise control signal 304 based on a thermal coefficient of the heating lamp 120 and/or the resistive dryer 118.

In another example, based on the linear phase control ramp being completed, the processor 102 may cause the heating lamp 120 to be heated using a half-cycle control signal 306. In addition, the heating lamp 120 may maintain the temperature of the conditioning mechanism 204 at or near the predefined temperature for the conditioning mechanism 204.

The processor 102 may also generate a dryer control signal 308 to heat the resistive dryer 118 to a predefined dryer temperature. In an example, the predefined dryer temperature may be based on the specifications of the resistive dryer 118. The processor 102 may, based on the nominal time consumed by the resistive dryer 118 for heating to the predefined dryer temperature and local regulatory requirements, perform a truncated phase control ramp for the heating lamp 120.

The processor 102 may fetch, decode, and execute the instructions 156 to generate a maintenance control signal 312 for the heating lamp 120 to cause the conditioning mechanism 204 to be maintained at the predefined temperature. The processor 102 may generate the maintenance control signal 312 with a reduced amount of phase control compared to when the heating lamp 120 is first warming up from an ambient temperature.

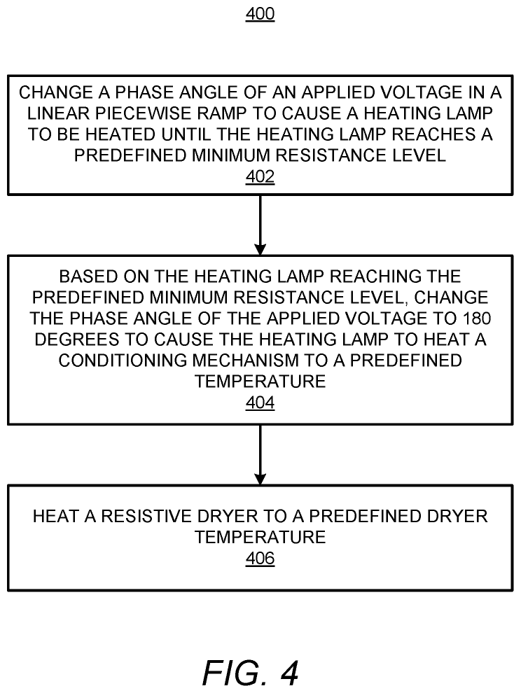

Various manners in which the processor 102 may operate are discussed in greater detail with respect to the method 400 depicted in FIG. 4. Particularly, FIG. 4 depicts a flow diagram of an example method 400 for controlling a resistive dryer 118 and a heating lamp 120 in a heated system 150, 200. It should be understood that the method 400 depicted in FIG. 4 may include additional operations and that some of the operations described herein may be removed and/or modified without departing from the scope of the method 400. The description of the method 400 is made with reference to the features depicted in FIGS. 1A-3 for purposes of illustration.

At block 402, the processor 102 may change a phase angle of the applied voltage in a linear piecewise ramp to cause a heating lamp 120 to be heated until the heating lamp 120 reaches a predefined minimum resistance level. In an example, the linear piecewise ramp may be based on the thermoelectrical resistance coefficient of the heating lamp 120. The nominal time for heating the heating lamp 120 until the heating lamp 120 reaches the predefined minimum resistance level may be determined empirically, experimentally or based on specifications of the heating lamp 120 provided by a manufacturer. As described above with reference to FIG. 1A, the linear phase control signal 304 may allow the heating lamp 120 to be heated as quickly as possible without causing a current surge that may cause flicker.

At block 404, the processor 102 may, based on the heating lamp 120 reaching the predefined minimum resistance level, change the phase angle of the applied voltage to 180 degrees to cause the heating lamp 120 to continue to heat a conditioning mechanism 204 to a predefined temperature but at a faster rate via 180 half cycle control. In an example, the predefined minimum resistance level may be based on the resistance above which flicker and/or maximum current are within a predefined value. For example, the predefined value may be determined by a standards-setting agency such as the Federal Communications Commission (FCC), the International Electrotechnical Commission (IEC), or the like.

At block 406, the processor 102 may heat a resistive dryer 118 to a predefined resistive dryer temperature. In an example, the predefined resistive dryer temperature may be based on the manufacturer's specifications for the resistive dryer 118. The processor 102 may generate the dryer control signal 308 to heat the resistive dryer 118, which may have a phase angle of 180 degrees for an applied voltage because the resistive dryer 118 may have a stable thermal coefficient that may be stable across a temperature range used in the printer. In addition, the processor 102 may heat the resistive dryer 118 concurrently with the application of voltage across the heating lamp 120 in the linear piecewise ramp.

In an example, the processor 102 may determine a cut-off time based on the first page out time 310. For example, the cut-off time may be the total time available for heating the heating lamp 120 and the resistive dryer 118 before the processor 102 may process a received print job. In another example, the processor 102 may determine the cut-off time based on the thermal coefficient of the heating lamp 120 and/or the resistive dryer 118. For example, the cut-off time may be based on the time thermal coefficient of the heating lamp 120 and the nominal time to heat the resistive dryer 118 to the predefined resistive dryer temperature.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is, therefore, to be understood that any electronic device capable of executing the above-described functions may perform those functions enumerated above.

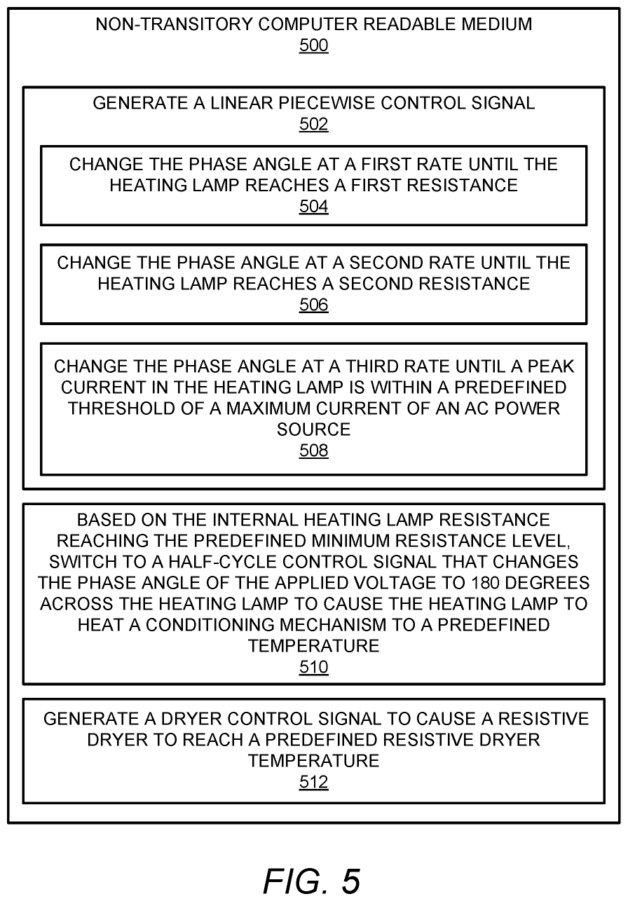

Turning now to FIG. 5, there is shown an example non-transitory computer readable medium 500 for controlling a heating lamp 120 and a resistive dryer 118 in a heated system 150, 200. The non-transitory computer readable medium 500 may be an electronic, magnetic, optical, or other physical storage device that contains or stores executable instructions. The computer readable medium 500 may be, for example, Random Access memory (RAM), an Electrically Erasable Programmable Read-Only Memory (EEPROM), a storage device, an optical disc, and the like.

The non-transitory computer readable storage medium 500 may have stored thereon machine readable instructions 502-512 that a processor, e.g., the processor 102, may execute. The machine readable instructions 502 may cause the processor to generate a linear piecewise control signal 304 that may increase a phase angle of an applied voltage in a circuit at a linear rate to heat a heating lamp 120 until an internal heating lamp resistance reaches a predefined minimum resistance. As discussed herein, the linear piecewise control signal 304 may be generated based on the thermal coefficient of the heating lamp 120. In an example, the linear piecemeal control signal 304 may operate a servo to control the phase angle of the voltage across the heating lamp 120. In an example, the predefined minimum resistance may be determined empirically or experimentally. The predefined minimum resistance may, for instance, be an internal resistance of the heating lamp 120 that does not cause a current surge that exceeds the CE, maximum current and flicker limits.

Particularly, for instance, to generate the linear piecewise control signal, the processor may execute the instructions 504 to change the phase angle of the applied voltage at a first rate of change when the heating lamp 120 is activated until the heating lamp 120 reaches a first resistance. In addition, the processor may execute the instructions 506 to change the phase angle of the applied voltage at a second rate of change until the heating lamp 120 reaches a second resistance. Furthermore, the processor may execute the instructions 508 to change the phase angle of the applied voltage at a third rate of change until a peak current in the heating lamp 120 is within a predefined threshold of a maximum current of an AC power source.

The processor may execute the instructions 510 to, based on the internal heating lamp resistance reaching the minimum resistance, switch to a half-cycle control signal 306 that may change the phase angle of the applied voltage to 180 degrees across the heating lamp 120 to cause the heating lamp 120 to heat a conditioning mechanism 204 to a predefined temperature. As described above, the predefined temperature may be empirically or experimentally determined. The processor 102 may cause the servo to change the phase angle of the applied voltage to 180 degrees in the heating lamp 120.

The processor may execute the instructions 512 to generate a dryer control signal 308 to cause the resistive dryer 118 to reach a predefined resistive dryer temperature. As described above, the processor may cause the resistive dryer 118 to be heated using a phase angle of 180 degrees for the voltage applied across the resistive dryer 118. The processor may concurrently generate the linear piecewise control signal 304 and the dryer control signal 308. In some examples, however, the processor may switch off supply of voltage across the heating lamp 120 before or after applying the voltage across the resistive dryer 118.

Although particular reference is made to a single heating lamp 120 in the descriptions of FIGS. 1A-5, it should be understood that features disclosed herein may also be applicable to an additional heating lamp or to multiple additional heating lamps. That is, for instance, the discussions pertaining to the generation of the linear piecewise control signal for the heating lamp 120 may equally be applied to an additional heating lamp in the heated system 150, 200.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored machine readable instructions that are to cause the processor to:
generate a linear piecewise control signal based on an internal resistance of a heating lamp to control a rate of change of a phase angle of an applied voltage in the heating lamp until a peak current in the heating lamp is within a predefined threshold of a maximum current rating of an alternating current (AC) power source of a circuit.

2. The apparatus of claim 1, wherein the instructions are further to cause the processor to:
based on the peak current in the heating lamp being within the predefined threshold, generate a half-cycle control signal to cause the heating lamp to heat a conditioning mechanism to a predefined temperature using the AC power source at a frequency of the AC power source; and
generate a dryer control signal to cause a resistive dryer to be heated to a predefined dryer temperature.

3. The apparatus of claim 2, wherein the instructions are further to cause the processor to truncate the linear piecewise control signal before the peak current in the heating lamp is within the predefined current threshold of a maximum current rating of the AC power source of the circuit, based on a nominal time consumed by the resistive dryer to be heated to a certain dryer temperature.

4. The apparatus of claim 2, wherein the instructions are further to cause the processor to generate a maintenance control signal that is to cause the conditioning mechanism to be maintained at the predefined temperature.

5. The apparatus of claim 2, wherein the linear piecewise control signal is based on a thermal coefficient of the heating lamp or the resistive dryer.

6. The apparatus of claim 2, wherein the half-cycle control signal changes the phase angle of the applied voltage to 180 degrees in the heating lamp.

7. The apparatus of claim 1, wherein the linear piecewise control signal is to:
change the phase angle of the applied voltage at a first rate of change when the heating lamp is activated, until the heating lamp reaches a first resistance;
change the phase angle of the applied voltage at a second rate of change until the heating lamp reaches a second resistance; and
change the phase angle of the applied voltage at a third rate of change until the peak voltage across the heating lamp is within the predefined threshold of a maximum voltage of the AC power source.

8. The apparatus of claim 7, wherein instructions are further to cause the processor to increase a step size of the phase angle changes in the linear piecewise control signal before the peak current in the heating lamp is within the predefined threshold of the maximum current rating of the AC power source.

9. The apparatus of claim 1, wherein the linear piecewise control signal is calibrated to prevent a current surge that exceeds a rated current of the AC power source.

10. A method comprising:
changing, by a processor, a phase angle of an applied voltage in a linear piecewise ramp to cause a heating lamp to be heated until the heating lamp reaches a predefined minimum resistance level; and
based on the heating lamp reaching the predefined minimum resistance level, changing, by the processor, the phase angle of the applied voltage to 180 degrees to cause the heating lamp to heat a conditioning mechanism to a predefined temperature.

11. The method of claim 10, further comprising:
heating, by the processor, a resistive dryer to a predefined dryer temperature.

12. The method of claim 11, wherein the linear piecewise ramp is based on a thermal coefficient of the heating lamp or the resistive dryer.

13. The method of claim 10, wherein the linear piecewise ramp is calibrated to prevent a current surge that exceeds a rated current of an AC power source.

14. A non-transitory computer readable medium comprising machine readable instructions executable by a processor to:
generate a linear piecewise control signal that increases a phase angle of an applied voltage in a circuit at a linear rate to heat a heating lamp until an internal heating lamp resistance reaches a predefined minimum resistance level;
based on the internal heating lamp resistance reaching the predefined minimum resistance level, switch to a half-cycle control signal that changes the phase angle of the applied voltage to 180 degrees in the heating lamp to cause the heating lamp to heat a conditioning mechanism to a predefined temperature; and
generate a dryer control signal to cause a resistive dryer to reach a predefined resistive dryer temperature.

15. The non-transitory computer readable medium of claim 14, wherein to generate the linear piecewise control signal, the instructions are further to cause the processor to:
change the phase angle of the applied voltage at a first rate of change when the heating lamp is activated until the heating lamp reaches a first resistance;
change the phase angle of the applied voltage at a second rate of change until the heating lamp reaches a second resistance; and
change the phase angle of the applied voltage at a third rate of change until a peak current in the heating lamp is within a predefined threshold of a maximum current of an AC power source.
